(19) United States
(12) Patent Application Publication
(10) Pub. No.: US 2004/0241385 A1
(43) Pub. Date: Dec. 2, 2004

(54) Thermochromatic curtain

(76) Inventor: Stephen Daniel Huseman, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 10/447,754

(22) Filed: May 29, 2003

(51) Int. Cl. B32B 3/06

(52) U.S. Cl. 428/99; 428/195.1

(57) ABSTRACT

A shower curtain has thermochromatic-inked images thereon. Once the ambient temperature reaches near the thermochromatic ink's activation temperature, the thermochromatic-inked images appear, disappear or change color. Alternatively, the curtain may also contain inked images which are not affected by changes in ambient temperature and upon a sufficient change in the ambient temperature, the thermochromatic-inked images may appear as an accessory to the inked images or the thermochromatic-inked images may reveal or cover all or part of the inked images.

### FIELD OF INVENTION

The present invention relates generally to a shower curtain, and is particularly directed to a shower curtain having thermochromatic images inked thereon.

### BACKGROUND OF THE INVENTION

Curtains have long been popular and have been mainly used as a functional component as well as a decorative component of a room. However, curtains have not changed much over time and provide little or no entertainment value. Consequently, a significant need exists for a curtain which can be functional, decorative as well as entertaining.

### BRIEF SUMMARY OF THE INVENTION

The present invention overcomes the above-noted deficiencies by providing a curtain which is entertaining and decorative yet economical.

In one aspect of the invention, a curtain has a thermochromatic image inked thereon. Depending on the thermochromatic ink selected, the image may change color, appear or disappear. The curtain is highly entertaining as the thermochromatic image changes color right before one's eyes, creates the illusion that the image is appearing out of nowhere or disappearing into thin air. The curtain is also decorative as the thermochromatic image may be configured to compliment a room's decor.

In another aspect of the invention, a curtain has thermochromatic image inked thereon and a nonthermochromatic image inked thereon. Depending on the thermochromatic ink selected, the image may change color, appear or disappear. The curtain is highly entertaining as the thermochromatic image changes color right before one's eyes, creates the illusion that the image is appearing out of nowhere or disappearing into thin air. The thermochromatic image may also be configured such that a disappearing thermochromatic image uncovers a nonthermochromatic image. The thermochromatic image may also be configured such that an appearing thermochromatic image covers a nonthermochromatic image. The curtain is also decorative as the thermochromatic image and the nonthermochromatic image may be configured to compliment a room's decorum.

In another aspect of the invention, a method is provided for the manufacture of a curtain having a thermochromatic image. This method produces the above mentioned curtains in an economical fashion.

These and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 shows a diagrammatic front view the curtain having a thermochromatic image inked thereon.

FIG. 2 depicts a diagrammatic view of the curtain of FIG. 1 after the thermochromatic image has been activated and has disappeared.

FIG. 3 shows a front view of a curtain having a thermochromatic image and a nonthermochromatic image inked thereon.

FIG. 4 depicts the curtain of FIG. 3 after the thermochromatic ink has been activated and the thermochromatic image has disappeared revealing an additional inked image.

### DETAILED DESCRIPTION OF THE INVENTION

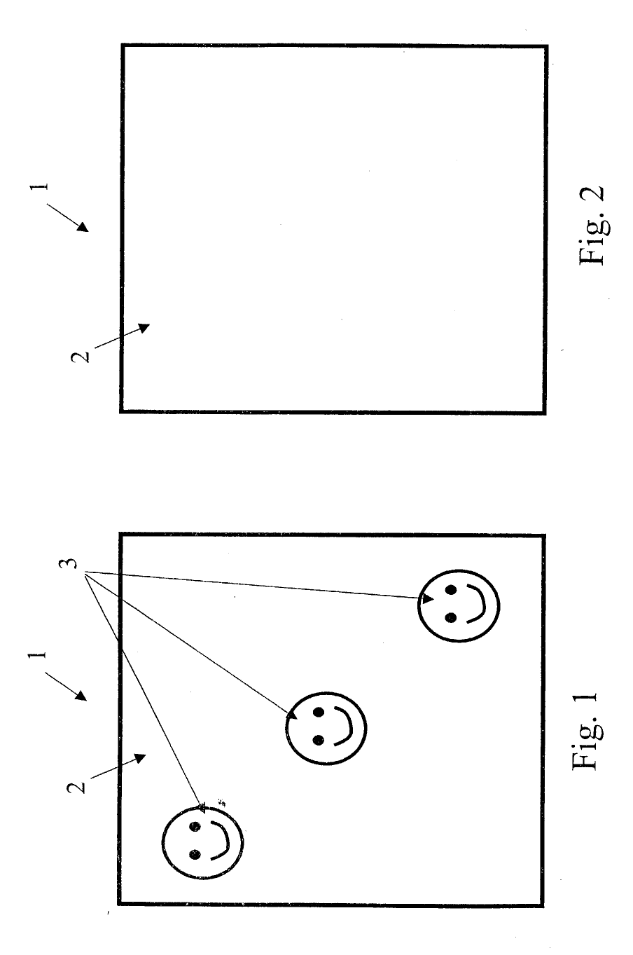

With reference to the drawings, FIG. 1 shows a thermochromatic curtain 1. The curtain is comprised of a flexible sheet 2, such as a polymeric sheet, and at least one thermochromatic images 3. The sheet may be transparent or opaque. The thermochromatic images 3 are comprised of thermochromatic ink. Thermochromatic ink is known in the art and, upon a sufficient change in the thermochromatic ink's temperature, may undergo reversible changes in its state such as a change in color, becoming opaque or becoming transparent; the temperature at which the thermochromatic ink changes states is typically known as the activation temperature and most thermochromatic inks will exhibit some changes within 8 degrees of their activation temperature. The activation temperatures for the different thermochromatic inks are known in the art and vary dependent upon the ink selected. An example of a suitable thermochromatic ink is DynaColor™ Thermochromic Inks available from Chromatic Technologies, Inc.

Thermochromatic inks may be applied to the flexible sheet 2 using most printing processes, including offset, flexography, screen-printing and spray on. The thermochromatic images 3 may be applied in small areas of the sheet 2 or may be applied over the entire sheet 2 and may also be applied such that the images either represents a specific object or objects, as shown in FIG. 1, an abstract image or a combination thereof. The curtain 1 is placed in an area that has sufficient changes in temperature to activate the thermochromatic ink. Upon a sufficient change in the ambient temperature, depending on the thermochromatic ink selected, the thermochromatic ink will become transparent, opaque or change color, which will cause the thermochromatic images 3 to seem as if they have disappeared, as shown in FIG. 2, appeared or changed color.

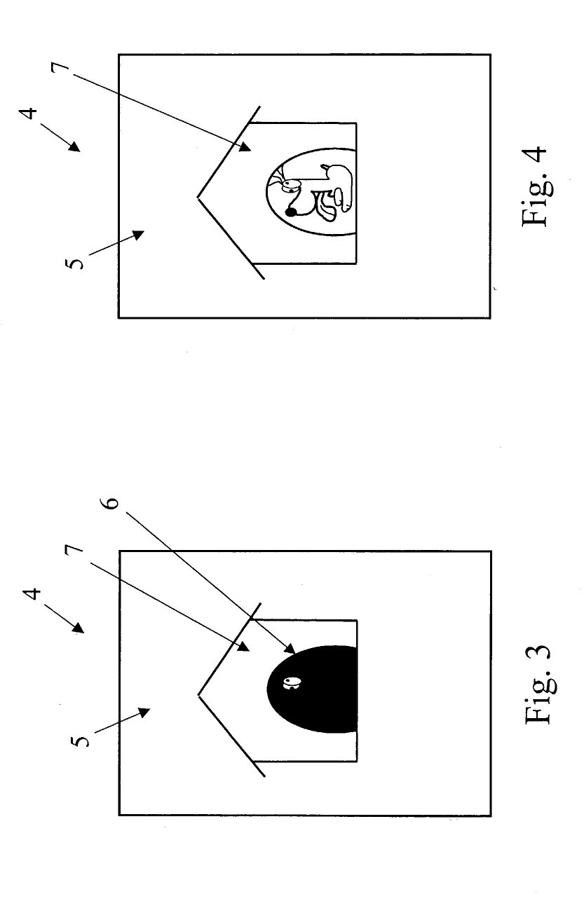

In an alternative embodiment, as shown in FIG. 3 and FIG. 4, a curtain 4 may comprise a flexible sheet 5, one or more thermochromatic images 6 and one or more nonthermochromatic images 7. The thermochromatic images 6 are comprised of thermochromatic ink and the nonthermochromatic images 7 are comprised of nonthermochromatic ink, such as a traditional ink or dye known in the art. Upon a sufficient change in the ambient temperature and depending on the thermochromatic ink selected, the thermochromatic images 6 may appear, disappear or change color as an accessory to the nonthermochromatic images 7, or, as shown in FIG. 3 and FIG. 4, the thermochromatic image 6 may disappear uncovering part of the nonthermochromatic image 7. The curtain may also be configured such that the thermochromatic image would disappear uncovering the entire nonthermochromatic image or configured such that the thermochromatic image would appear covering part of or the entire nonthermochromatic image.

Depending on the application, it may be advantageous to use a sealant to protect the thermochromatic images and/or the nonthermochromatic images from external threats to the integrity of the images such as moisture, dirt, and direct contact with the surrounding environment. The sealant may be a conventional sealer, such as a polypropylene film or other similar sealant, as well as an additional flexible sheet such that the thermochromatic images and nonthermochromatic images are applied to one or both sheets and then “sandwiched” between the two flexible sheets.

The curtain may be configured to hung as a shower curtain. For example, holes may be placed along the top edge of the sheet for accepting hooks or rings to be hung on a vertical rod or loops of fabric or a similar material as the sheet could be attached near the top edge of the sheet such that a rod could be threaded through the loops.

The curtain could also be configured to be hung as a window covering, a window curtain, a window shade, a door covering, a door curtain or a wall covering by using such things as tacks, nails, screws, suction cups, hooks, or hooks with a rod. The curtain may also be simply draped over an object or objects.

In use, the thermochromatic curtain would be hung as a shower curtain in a bathroom. The shower would be turned on and the heat from water would activate the thermochromatic ink causing the images to disappear. Once the shower was turned off and the heat captured in the bathroom dissipates, the thermochromatic images would reappear.

While the present invention has been illustrated by the description of several embodiments and while the illustrative embodiments have been described in considerable detail, it is not the intention of the applicant to restrict or in any way limit the scope of the appended claims to such detail. Additional advantages and modifications may readily appear to those skilled in the art.

For example, a curtain may incorporate multiple thermochromatic images, all of which are activated at different temperature ranges. As another example, a curtain may incorporate one or more inked images and multiple thermochromatic images, all of which are activated at different temperature ranges.

What is claimed is:

1. A curtain comprising:
a flexible sheet having an application side; and
a thermochromatic image comprised of thermochromatic ink having a first state at a first temperature and having a second state at a second temperature;
wherein said image is applied to said application side of said flexible sheet.

2. The curtain of claim 1, wherein said first state of said thermochromatic ink at said first temperature is opaque and wherein said second state of said thermochromatic ink at said second temperature is transparent.

3. The curtain of claim 1, wherein said first state of said thermochromatic ink at said first temperature presents a first color and wherein said second state of said thermochromatic ink at said second temperature presents a second color.

4. The curtain of claim 1, further comprising a sealant applied to said application side of said flexible sheet over said image.

5. The curtain of claim 4, wherein said first state of said thermochromatic ink at said first temperature is opaque and wherein said second state of said thermochromatic ink at said second temperature is transparent.

6. The curtain of claim 5, wherein said flexible sheet further comprises a plurality of curtain hanging attachments.

7. The curtain of claim 4, wherein said first state of said thermochromatic ink at said first temperature presents a first color and wherein said second state of said thermochromatic ink at said second temperature presents a second color.

8. The curtain of claim 7, wherein said flexible sheet further comprises a plurality of curtain hanging attachments.

9. A curtain comprising:
a flexible sheet having an application side;
a thermochromatic image comprised of thermochromatic ink having a first state at a first temperature and having a second state at a second temperature; and
a nonthermochromatic image comprised on nonthermochromatic ink;
wherein said images are applied to said application side of said flexible sheet.

10. The curtain of claim 9, wherein said first state of said thermochromatic ink at said first temperature is opaque and wherein said second state of said thermochromatic ink at said second temperature is transparent.

11. The curtain of claim 9, wherein said first state of said thermochromatic ink at said first temperature presents a first color and wherein said second state of said thermochromatic ink at said second temperature presents a second color.

12. The curtain of claim 9, further comprising a sealant applied to said application side of said flexible sheet over said images.

13. The curtain of claim 12, wherein said first state of said thermochromatic ink at said first temperature is opaque and wherein said second state of said thermochromatic ink at said second temperature is transparent.

14. The curtain of claim 13, wherein said flexible sheet further comprises a plurality of curtain hanging attachments.

15. The curtain of claim 12, wherein said first state of said thermochromatic ink at said first temperature presents a first color and wherein said second state of said thermochromatic ink at said second temperature presents a second color.

16. The curtain of claim 15, wherein said flexible sheet further comprises a plurality of curtain hanging attachments.

17. A method of manufacturing a curtain comprising the steps of:
providing a flexible sheet having an application side; and
applying thermochromatic ink to said application side of said flexible sheet.

18. The method of claim 17, further comprising the step of applying nonthermochromatic ink to said application side of said flexible sheet.

19. The method of claim 17, further comprising the step of applying a sealant to said application side of said flexible sheet such that said thermochromatic ink is situated between said sealant and said flexible sheet.

20. The method of claim 17, further comprising the step of adapting said flexible sheet to receive at least one fastener.
